(19) United States
(12) Patent Application Publication
(10) Pub. No.: US 2022/0377233 A1
(43) Pub. Date: Nov. 24, 2022

(54) Utilizing Changing Photographer Pupil Size Information To Determine Appropriate Camera Settings

(71) Applicant: David Michael Tillinghast, Thetford Center, VT (US)

(72) Inventor: David Michael Tillinghast, Thetford Center, VT (US)

(21) Appl. No.: 17/324,178

(22) Filed: May 19, 2021

(51) Int. Cl. H04N 5/232

(52) U.S. Cl. CPC H04N 5/23219

(57) ABSTRACT

The changing size of a person's pupil looking through a camera's viewfinder can be used to calculate more accurate exposure settings to allow for pictures to be taken more optimally exposed. Relative pupil size information can also indicate that the photographer is looking at one object in the frame with certain light values versus another object, helping auto tracking systems determine which object should be tracked. When a single object has a wide divergence of light values on it, the photographer's pupil size may help indicate which would be most appropriate to use to automatically calculate the appropriate exposure settings.

### TECHNICAL FIELD

The following description relates generally to automated systems employed in photography to determine the most appropriate settings for a camera given changing environmental conditions and composition choices.

### BACKGROUND

As photography moved from a chemical-film process to digital data collection, more and more software tools and processes can be applied to the process to improve the odds of a given shot being successful in capturing what a camera user wishes to photograph. Further, such digital innovations give rise to still more potential to integrate and improve upon a wider array of factors and processes.

One such set of innovations making great progress has been the automatic selection of the desired focus point via what is called “subject tracking.” A processor in the camera uses software to identify different types of objects and can do so quickly enough now that the camera can adjust the “focal point,” or the place in the frame from which it determines the proper focal plane. The camera will then drive a lens's adjustable focus mechanism to match that plane so as to be able to create a crisply focused image. Common examples of subject tracking include “eye-detect” tracking, which will track a model's eye placement, and use a separate mechanism to determine that location's distance from the sensor and appropriately adjust the focus continuously.

The field of “deep learning” software development has been a great boon to the camera manufacturing industry, with subject tracking becoming more and more common as the software developers at camera making firms.

Additionally, at least one camera manufacturer is again using a technology it employed decades ago that employs user eye part movements information to augment this focus point selection process. The technology employs a user-facing sensor that tracks the movement of an eye part looking into the viewfinder on the x and y axes, and computes the gaze direction of the photographer, thereby finding the desired focus point.

The relationship between eye part position and where a user is looking is a well-worn area of research. But there is more information available by measuring additional dimensions of a pupil. Pupils expand to take in more light when conditions are dark, and they contract when conditions are light. This is very useful for helping determine exposure settings: those settings of exposure time, aperture, ISO and exposure compensation.

Also, it was established in two recent academic studies that pupils similarly expand and contract when viewers are thinking about different elements of the scene in front of them that have differentiated light values. [The Pupillary Light Response Reflects Visual Working Memory Content; Hustá et. al.; bioRxiv; Nov. 27, 2018 and Modulation of the Pupillary Response by the Content of Visual Working Memory; Zokaeie et. al.; Proceedings of the National Academy of Sciences; Nov. 5, 2019]

### SUMMARY

Because pupil dilation is a good indicator of viewed light values, detecting changes in pupil size can help a camera better adapt camera settings to the appropriate exposure settings. This is particularly useful now that cameras have advanced to the point where they are algorithmically determining which of the objects in the field of view are the appropriate subject and are tracking them with high degree of accuracy even as the subjects move through the frame.

In particular, there is value in combining the three dimensions of vertical and horizontal position along with the diameter of a pupil, where the pupil betrays the user's mental point of attention within the area in which the eye is looking.

This invention contemplates detecting pupil dilation of the eye in the viewfinder and incorporating that information into the iterating exposure adjustment process.

Further, because of a phenomenon where a user's mental concentration on a subject of a particular set of light values will cause pupil contraction or dilation, as referenced above, this information can also be employed by the algorithm to more accurately determine the target intended. Put bluntly, the pupils aren't just revealing the proper level of light required, but also what the photographer is intending to shoot. That allows for further refinements to the exposure values, as well as potentially help prioritize which of discrete objects detected is the actual one that the user wishes to follow—at least in the case that these objects have different light values.

The current development of deep learning software in camera autofocus systems is now at a point where tracking a changing focal point (for instance, in the case of a moving dancer) is more easily and accurately done relying on the camera's computing systems. Some now have the ability to recognize a target type, such as an eye or a bird, and then continually update its x and y coordinates with refreshed data from the camera sensor many times per second. This makes the initial target selection of the focal point very important, as it can be maddening to a user to have the camera believe the wrong item is the object of desired focus. Measuring the pupil dilation at this time can help determine what is the intended target.

Finally, in addition to providing potentially more accurate exposure desire information, the mechanism of detecting pupil size is much faster than demanding a user manually change settings. A large portion of an action photographer's attention today is focused on using controls to keep the focus point in the appropriate place, and in some cases, using the same method to tell the camera which place in the frame was the prioritized light values for which it should adjust exposure settings. This focus point selection may be done with a small joystick on the back of the camera, with dials, or by touching a touch-sensitive screen, among other methods.

### DESCRIPTION OF DRAWINGS

FIG. 1 Is an exemplary depiction of the light path when a person uses a camera.

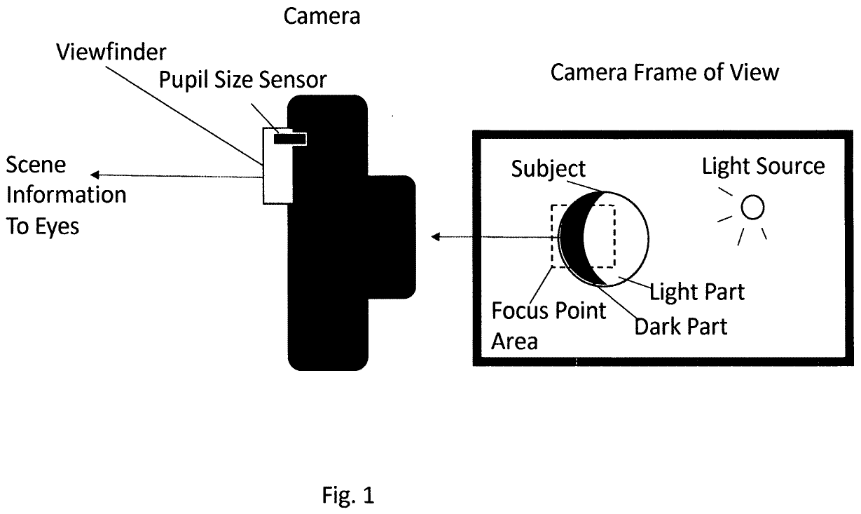

FIG. 2 Is an exemplary depiction of pupil reactions when a person views a different portion of the field of view when it has a different set of light values.

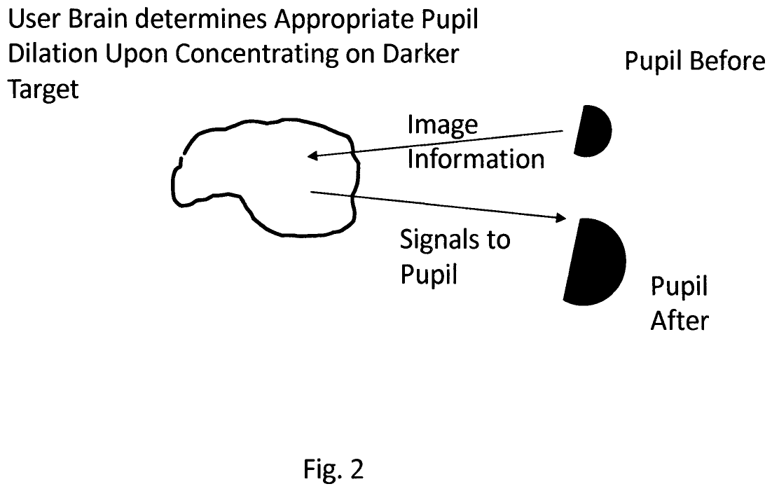

FIG. 3 Is an exemplary depiction of the direction in which a photographer's brain signals to the pupils to contract or dilate depending on the viewfinder information received.

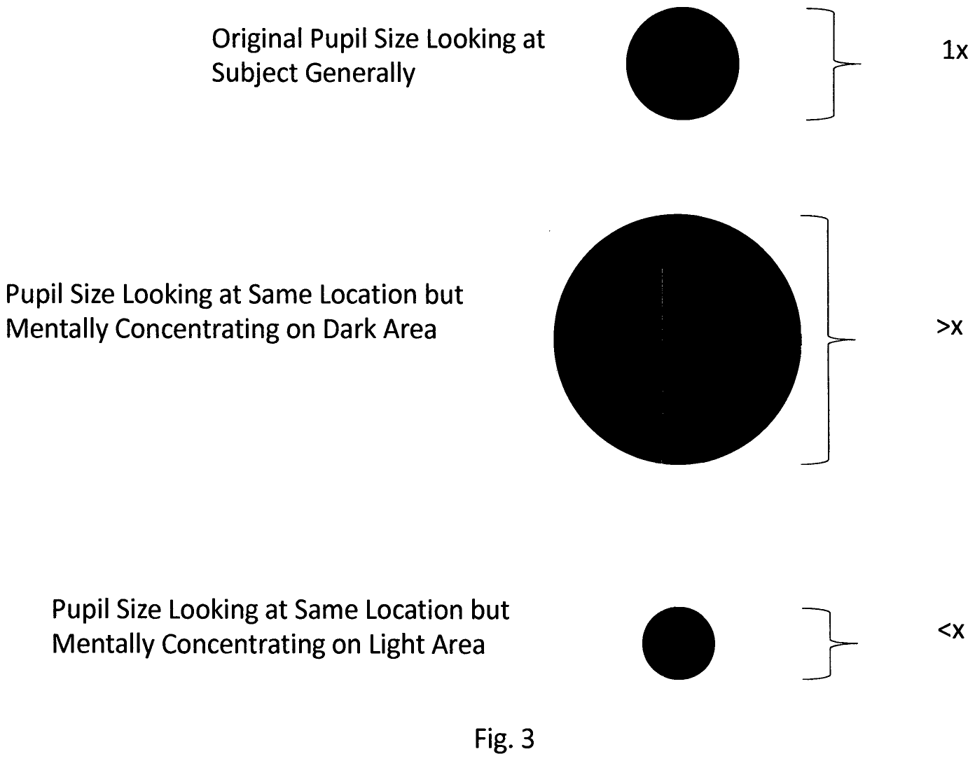

### DETAILED DESCRIPTION

Modern digital cameras typically provide multiple processes for determining the proper focus point within an image and to set the appropriate exposure values. The focus point is important for focus control, but it also can also help determine other information, such as what might be the desired exposure adjustments for a user.

Among the methods for determining the appropriate focus point is one that tracks a user's eye part position to determine the direction of gaze, thus determining what the user wishes to photograph. Some cameras also use the determined focus point to calculate a more accurate assessment of what would be appropriate exposure values. An example: if, within a generally dark scene, the focus point selected happens to be on a subject that has brighter values, the camera's current exposure settings can be automatically adjusted to the brighter area, despite it being a small portion of the field of view.

The focus areas used to determine the appropriate adjustment may cover a small part of the camera's view, or large part. In both cases, the light values are generally averaged or employ an alternate algorithm to determine an appropriate adjustment. Subject recognition technology may also be employed to improve the camera's estimated appropriate exposure adjustment.

The human brain controls eye pupil dilation based generally on the amount of light reflecting off a viewed subject. It is further adjusted based on the light values reflecting off the particular part about which the person is thinking. For example, if a viewer observes a sphere half in shadow, the pupil may be set by the brain at a width of x. Were the viewer to maintain the same eye and pupil direction but think about the dark side of that sphere, the brain has been shown to open the pupil further than x to provide more light in compensation. If the viewer opts to think about the light side of the sphere, the brain will similarly adjust the pupil to a smaller size than x.

These two biological mechanisms—firstly adjusting the size of the pupil to let in the appropriate amount of light; and secondly the further adjustment of the size of the pupil due to the brain's concentration on a specific part of the subject—together provide critical exposure information that can be conveyed quickly to a camera by measuring the current pupil width. This may prove especially useful when there is a wide divergence of light values within a small area.

In addition to providing potentially more accurate exposure desire information, the speed with which a user provides that data to the camera can be vastly accelerated, as it does not require manual settings adjustments.

Additionally, the user's pupil size can give information as to what the user desires to make the subject of a photo. Many current subject recognition systems use deep learning methods to train a system to recognize likely desired subjects, such as a bird, or the eye of a model. When a system's algorithm is choosing from among the best recognized objects options, the pupil size of the user may imply the user is favoring one of the objects over another to be the prime subject.

### REFERENCES

There is prior art not for this invention, but in the nearby fields of pupil size detection and the use of pupil size to control lighting for a person. Two examples of the former would be:

| | | |
|---|---|---|
| 20529735 | March 2019 | CN |
| 2020/0100670 | November 2020 | Hoggarth, et al. |

The latter, dealing with controlling lighting can be seen in the Japanese patent application below:

| | | |
|---|---|---|
| JP2005219583 | February 2004 | JP |

More specific to the camera industry, several important developments in eye tracking happened through the 70s and 80s, culminating in Canon's actual release of an eye-tracking camera, the EOS 3 that used a face detection sensor to determine what the photographer was viewing through the viewfinder.

Pupil detection has been used for numerous applications, such as creating heat maps to indicate what people actually read on a page, and to help people operate computers who can't use theft hands.

My search failed to turn up instances of the use of pupil size changes used to determine the desired exposure levels of a scene based on the combination of a viewer's subject selection and the autonomic responses of his brain.

What is claimed is:

1. An automatic camera settings adjustment method, comprising:
a means of measuring changes in user pupil diameter;
a means to communicate that value to one of the camera's computer processors;
a means for the camera to incorporate that information into its updating calculations for optimal exposure settings; and
a means to adjust relevant camera settings of exposure time, aperture size, ISO, exposure compensation, or optimal focus point selection.

2. Software stored on a computer readable medium, the software including instructions to cause a computer processor to:
use a detected increase in user pupil size to calculate an adjustment factor for one or more exposure settings to increase the exposure value; and
to use a decrease in user pupil size to calculate an adjustment adjust factor for one or more exposure settings to decrease the exposure value.

3. Software stored on a computer readable medium, the software including instructions to cause a computer processor to:
cause a camera with a subject tracking system that detects multiple subject options from which to choose to select the subject option that is most appropriately matched to the desired exposure value implied by the size of the user's pupil.
